(19) United States
(12) Patent Application Publication
(10) Pub. No.: US 2011/0182166 A1
(43) Pub. Date: Jul. 28, 2011

(54) OPTICAL PICKUP

(76) Inventors: Daisuke TOMITA, Yokohama (JP); Akio Yabe, Fujisawa (JP); Kazuhiro Todori, Yokohama (JP); Jun Hato, Fujisawa (JP)

(21) Appl. No.: 12/862,995

(22) Filed: Aug. 25, 2010

(30) Foreign Application Priority Data
Jan. 28, 2010 (JP) 2010-016283

(51) Int. Cl. G11B 7/135

(52) U.S. Cl. 369/112.24; G9B/7.121

(57) ABSTRACT

An optical pickup that can be downsized is suggested.

The optical pickup includes: a collimator lens positioned on an optical path of a laser beam between a laser diode and an objective lens; and a collimator lens moving unit for moving the collimator lens along the optical path of the laser beam in a direction approaching the objective lens or a direction moving away from the objective lens; wherein a reference position of the collimator lens where the laser beam which has transmitted the collimator lens becomes parallel rays is set at an end or an approximately end of a movable range of the collimator lens that is closest to the objective lens; and wherein the objective lens is formed so that spherical aberration occurring in the laser beam which is made to converge on an outermost recording layer of the multilayered optical disc that is closest to the objective lens can be cancelled by spherical aberration occurring in the laser beam entering the objective lens through the collimator lens located at the reference position.

### CROSS-REFERENCES TO RELATED APPLICATIONS

This application relates to and claims priority from Japanese Patent Application No. 2010-016283, filed on Jan. 28, 2010, the entire disclosure of which is incorporated herein by reference.

### BACKGROUND

1. Field of the Invention

The invention relates to an optical pickup and is suited for use in, for example, an optical pickup mounted in an optical disc device that is capable of data recording and/or regeneration on multilayered optical discs.

2. Description of Related Art

With a conventional optical disc device, an objective lens makes a laser beam, which has been emitted from a laser diode, converge on a recording layer of an optical disc and regenerates data recorded on the recording layer according to changes of the light quantity of the laser beam reflected on the recording layer.

It is known with the above-described optical disc device that spherical aberration of size corresponding to a thickness of part of an optical disc extending from its surface where the laser beam enters (hereinafter simply referred to as the “plane of laser beam incidence) to its recording layer occurs in the laser beam until the laser beam which has entered the optical disc reaches the recording layer.

In this case, the thickness of part of an optical disc extending from its plane of laser beam incidence to its recording layer is defined according to standards provided in advance for each type of optical discs such as Blu-ray Discs (BD), Digital Versatile Discs (DVD), or Compact Discs (CD). Accordingly, with conventional optical disc devices, for example, the shape of an objective lens is designed in advance so that spherical aberration occurring in the optical disc can be canceled by spherical aberration occurring when the laser beam passes through the objective lens.

Meanwhile, a multilayered optical disc having a plurality of recording layers has emerged in recent years. Since the distance between the plane of laser beam incidence and each recording layer in such a multilayered optical disc varies for each recording layer, the size of spherical aberration occurring in the laser beam until the laser beam reaches each recording layer varies for each recording layer. Therefore, with the multilayered optical disc, an objective lens cannot be formed so that the spherical aberration occurring in the laser beam can be canceled with respect to all the recording layers.

Accordingly, Japanese Patent No. 3189616 previously suggested a method for limiting the influence of spherical aberration on each recording layer to be within a permissible range with respect to an optical disc device capable of data recording and/or regeneration on a double-layered optical disc having two recording layers by forming an objective lens so that spherical aberration occurring in the laser beam passing through the objective lens will be minimized at an arbitrary position between the two recording layers.

Recently, the following method is also suggested, with respect to an optical disc device capable of data recording and/or regeneration on a multilayered optical disc, for adjusting the size of spherical aberration occurring in a laser beam transmitting through an objective lens, by moving a collimator lens, which is located on an optical path of the laser beam, along an optical axis of the laser beam in a direction approaching the objective lens or a direction moving away from the objective lens, thereby causing the laser beam entering the objective lens to change to converging or diverging rays. This method can ensure that the spherical aberration occurring in each recording layer when the laser beam passes through the optical disc will be canceled by the spherical aberration occurring when the laser beam transmits through the objective lens. Therefore, this method is particularly effective for an optical disc device capable of data recording and/or regeneration on a multilayered BD that is susceptible to spherical aberration and for which the wavelength of a laser beam is short.

In recent years, the number of layers provided in an optical disc has been increasing and the development of an optical disc having three or more layers has been promoted. Accordingly, the distance between the outermost recording layer of an optical disc (a recording layer closest to a plane of laser beam incidence from among a plurality of recording layers formed in the optical disc) and the deepest recording layer (a recording layer farthest from the plane of laser beam incidence from among the plurality of recording layers formed in the optical disc) has been increasing.

If an optical pickup is configured under the circumstances described above so that the size of spherical aberration occurring in the laser beam transmitting through the objective lens as described above can be adjusted by the position of the collimator lens, it is necessary to increase the movable range of the collimator lens so that larger spherical aberration can occur. Such expansion of the movable range of the collimator lens also inhibits downsizing of the optical pickup.

### SUMMARY

The present invention was devised in light of the circumstances described above and aims at suggesting an optical pickup that can be downsized.

In order to solve the above-mentioned problem, an optical pickup mounted in an optical disc device capable of data recording and/or regeneration on a multilayered optical disc having a plurality of recording layers is provided according to this invention, wherein the optical pickup includes: a laser diode for emitting a laser beam; an objective lens for making the laser beam, which has been emitted from the laser diode, converge on the recording layers of the multilayered optical disc; a collimator lens positioned on an optical path of the laser beam between the laser diode and the objective lens; and a collimator lens moving unit for moving the collimator lens along the optical path of the laser beam in a direction approaching the objective lens or a direction moving away from the objective lens; wherein a reference position of the collimator lens where the laser beam which has transmitted the collimator lens becomes parallel rays is set between an approximately center area of a movable range of the collimator lens to an end of the movable range closer to the objective lens; and wherein the objective lens is formed so that spherical aberration occurring in the laser beam which is made to converge on an outermost recording layer of the multilayered optical disc that is closest to the objective lens can be cancelled by spherical aberration occurring in the laser beam entering the objective lens through the collimator lens located at the reference position.

This invention can downsize an optical pickup 16 and thereby further downsize the whole optical disc device 1.

### BRIEF DESCRIPTION OF THE DRAWINGS

FIG. 1 is a block diagram showing the overall configuration of an optical disc device according to a first embodiment.

FIG. 2 is a schematic diagram showing the schematic configuration of an optical pickup according to the first embodiment.

FIG. 3(A) to FIG. 3(C) are schematic diagrams explaining the optical pickup shown in FIG. 2.

FIG. 4(A) to FIG. 4(C) are schematic diagrams explaining the optical pickup shown in FIG. 2.

FIG. 5(A) and FIG. 5(B) are schematic diagrams explaining the principle of the configuration of an optical pickup according to a second embodiment.

FIG. 6 is a schematic diagram explaining the principle of the configuration of the optical pickup according to the second embodiment.

FIG. 7 is a schematic diagram explaining the schematic configuration of the optical pickup according to the second embodiment.

### DETAILED DESCRIPTION OF PREFERRED EMBODIMENTS

An embodiment of the present invention will be explained with reference to the attached drawings.

### (1) First Embodiment

### (1-1) Configuration of Optical Disc Device According to this Embodiment

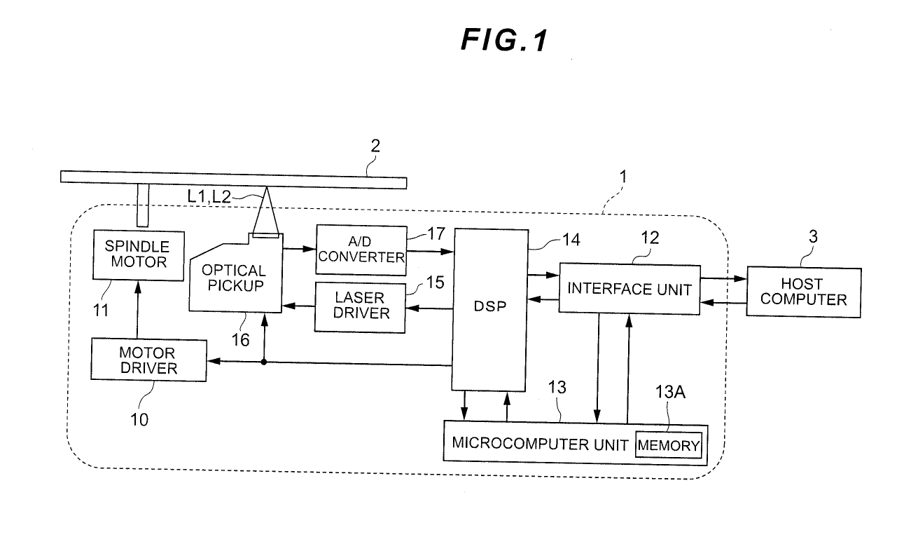

Referring to FIG. 1, the reference numeral “1” represents an optical disc device 1 according to this embodiment as a whole. This optical disc device 1 is capable of data recording and/or regeneration on an optical disc 2, such as a multilayered BD, DVD, or CD in addition to a single-layered BD, DVD, or CD, and is designed so that it can record data on the optical disc 2 or regenerate data recorded on the optical disc 2 in response to a request from a host computer 3.

In fact, with this optical disc device 1, the optical disc 2 mounted in a specified state is rotated in a rotation condition according to a recording method (such as a CAV method or a CLV method) for the optical disc 2 by having a motor driver 10 drive a spindle motor 11 under the control of a digital signal processor 14.

Also, the optical disc device 1 inputs various commands, which have been sent from the host computer 3, to a microcomputer unit 13 via an interface unit 12.

The microcomputer unit 13 includes a memory 13A storing a control program and executes commands issued from the host computer 3 and necessary control processing and arithmetic processing according to various information supplied from the digital signal processor 14.

For example, if the microcomputer unit 13 receives a recording command from the host computer 3, it controls the interface unit 12 to send object data to be recorded, which is to be sent from the host computer 3, to the digital signal processor 14.

The digital signal processor 14 executes specified signal processing including modulation processing on the object data to be recorded, which is supplied via the interface unit 12, and sends the obtained recording signal as a driving signal to a laser driver 15.

The laser driver 15 drives a laser diode in the optical pickup 16 to make it blink based on the driving signal supplied from the digital signal processor 14. As a result, a laser beam L1 whose light quantity is based on a blinking pattern according to the content of the driving signal (recording signal) and a signal level of the driving signal is emitted from the laser diode and the laser beam L1 is made to converge, via the objective lens in the optical pickup 16, on recording layers 2A of the optical disc 2. As a result, the object data is recorded on the optical disc 2.

Reflected light L2 of the laser beam L1 which is reflected on the optical disc 2 is received by a photodetector (described later) in the optical pickup 16 and undergoes photoelectric conversion. Subsequently, an RF (Radio Frequency) signal obtained as a result of the above-mentioned photoelectric conversion undergoes digital conversion by an analogue-to-digital converter 17 and is converted into a digital RF signal, which is then supplied to the digital signal processor 14.

The digital signal processor 14 generates various control signals, such as a focus error signal, a tracking error signal, and a rotation control signal, based on the supplied digital RF signal. Accordingly, a biaxial actuator (not shown in the drawing) in the optical pickup 16 is controlled according to the focus error signal and the tracking error signal, thereby implementing focus control and tracking control. The rotation control signal is supplied to the motor driver 10 and the rotation of the spindle motor 11 is controlled by the motor driver 10 according to this rotation control signal.

Meanwhile, when the microcomputer unit 13 receives a regeneration command from the host computer 3 via the interface unit 12, it controls the digital signal processor 14 and thereby has it send a specified control signal to the laser driver 15.

The laser driver 15 drives the laser diode in the optical pickup 16 based on the supplied control signal to drive the laser diode to turn it on at a specified voltage. As a result, this laser diode emits a laser beam of specified power, which is made to converge, via the above-mentioned objective lens, on the recording layers 2A of the optical disc 2.

The reflected light L2 of this laser beam L1 which is reflected on the optical disc 2 undergoes photoelectric conversion by the photodetector in the optical pickup 16; and the RF signal thus obtained undergoes digital conversion by the analogue-to-digital converter 17 and then supplied as a digital RF signal to the digital signal processor 14.

The digital signal processor 14 executes regenerated signal processing such as demodulation processing on the supplied digital RF signal and then sends the obtained regenerated data via the interface unit 12 to the host computer 3.

Also, the digital signal processor 14 generates various control signals, such as a focus error signal, a tracking error signal, and a rotation control signal, based on the digital RF signal in the same manner as when recording data. Accordingly, the focus control, tracking control, and rotation control of the spindle motor 11 are performed based on the focus error signal, the tracking error signal, and the rotation control signal in the same manner as when recording data.

### (1-2) Configuration of Optical Pickup According to this Embodiment

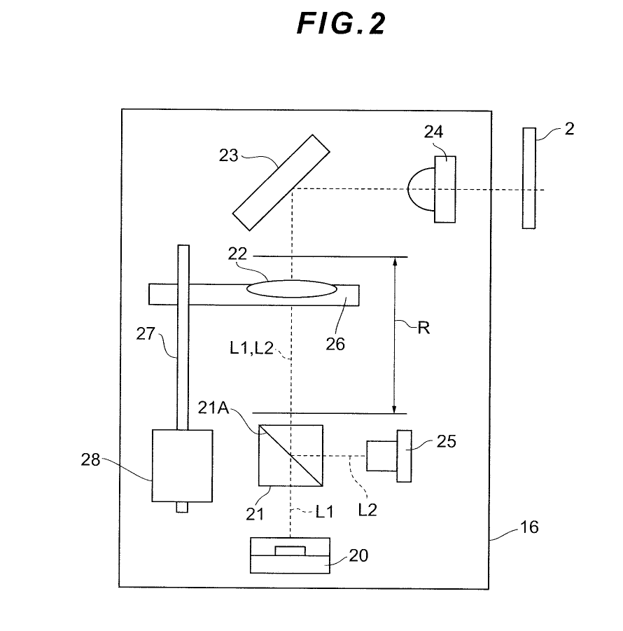

FIG. 2 shows the schematic configuration of the optical pickup 16. As is apparent from FIG. 2, the optical pickup 16 includes a laser diode 25, a polarization beam splitter 21, a collimator lens 22, a reflecting mirror 23, and an objective lens 24.

The laser diode 25 emits a laser beam of a wavelength according to the type of the mounted optical disc 2 under the control of the laser driver 15. The laser beam L1 emitted from this laser diode 25 is delivered sequentially through the polarization beam splitter 21 and the collimator lens 22 to the reflecting mirror 23. The laser beam L1 delivered to the reflecting mirror 23 is reflected on this reflecting mirror 23 in a given direction and then enters the objective lens 24; and this objective lens 24 makes the laser beam L1 converge on the target recording layers in the optical disc 2.

Furthermore, the reflected light L2 of the laser beam L1 which is reflected on the optical disc 2 enters the polarization beam splitter 21 via the reflecting mirror 23 and the collimator lens 22 and is then reflected on a polarizing film 21A of this polarization beam splitter 21 in a given direction and enters a light-receiving surface of a photodiode 20. The photodiode 20 implements photoelectric conversion of the reflected light L2, which has entered the light-receiving surface, and outputs the obtained RF signal to the analogue-to-digital converter 17 as described earlier.

In addition, in the case of the optical pickup 16, the collimator lens 22 is held by a holder 26 and the holder 26 engages with a ball screw 27 positioned in parallel with an optical path of the laser beam. The ball screw 27 is designed so that it can rotate around the central axis of a stepping motor 28 based on its rotation output. Driving of the stepping motor 28 is controlled by the digital signal processor 14.

Consequently, the optical pickup 16 is configured so that the collimator lens 22 can be moved along the optical path of the laser beam L1 in a direction approaching the objective lens 24 or a direction moving away from the objective lens 24 by driving the stepping motor 28.

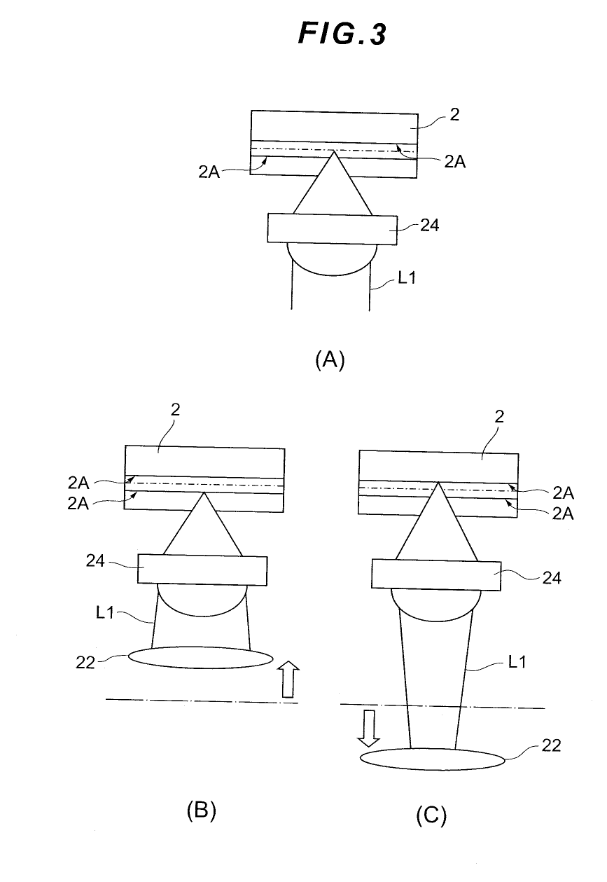

Accordingly, with the optical pickup 16, the laser beam L1 entering the objective lens 24 can be changed from parallel rays in a state as shown in FIG. 3(A) where it transmits through the collimator lens 22 and enters the objective lens 24 (the position of the collimator lens 22 in this state will be hereinafter referred to as the “reference position”) to converging rays as shown in FIG. 3(B) by moving the collimator lens 22 in a direction approaching the objective lens 24. In this case, spherical aberration occurring when the laser beam L1 transmits through the objective lens 24 increases in a negative polarity (−) direction on the basis of the state shown in FIG. 3(A).

Furthermore, the laser beam L1 entering the objective lens 24 can be changed to diverging rays by moving the collimator lens 22 from the state shown in FIG. 3(A) to a state shown in FIG. 3(C) by moving the collimator lens 22 in a direction moving away from the objective lens 24. In this case, the spherical aberration occurring when the laser beam L1 transmits through the objective lens 24 increases in a positive polarity (+) direction on the basis of the state shown in FIG. 3(A).

In this way, the optical pickup 16 is designed so that the size of the spherical aberration occurring in the laser beam L1 that transmits through the objective lens 24 can be freely adjusted by adjusting a displacement amount of the collimator lens 22 from the reference position.

Recently, the development of multilayered optical discs 2 including three or more layers has been promoted. As a result, the distance between the outermost recording layer 2A of the optical disc 2 closer to the objective lens 24 and the deepest recording layer 2A has been increasing. If the optical pickup 16 is configured under the above-described circumstance so that the size of the spherical aberration occurring in the laser beam L1 which transmits through the objective lens 24 can be adjusted by changing the position of the collimator lens 22 as described above, it is necessary to expand a movable range R of the collimator lens 22 in order to obtain a larger adjustment amount. Such expansion of the movable range R of the collimator lens 22 also inhibits downsizing of the optical pickup 16.

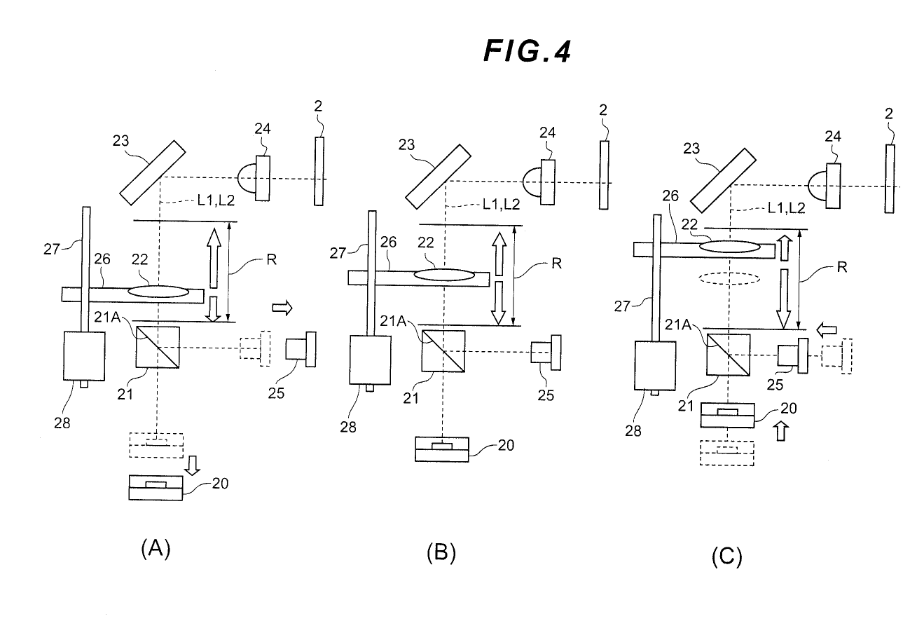

Now, for example, on the basis of a case shown in FIG. 4(B) where the reference position of the collimator lens 22 is set to an approximately center position of the movable range R of the collimator lens 22 in the optical pickup 16, the following cases are examined: a case shown in FIG. 4(A) where the reference position of the collimator lens 22 is set to an end of the movable range R of the collimator lens 22 that is farthest from the objective lens 24; and a case shown in FIG. 4(C) where the reference position of the collimator lens 22 is set to an end of the movable range R of the collimator lens 22 that is closest to the objective lens 24.

Incidentally, FIG. 4(B) shows the setting where spherical aberration occurring when the laser beam L1 passing through the optical disc 2 can be canceled by spherical aberration occurring in the objective lens 24 when the laser beam L1 is made to converge at an approximately center position between the outermost recording layer of the multilayered optical disc 2 and its deepest recording layer. Moreover, FIG. 4(A) shows the setting where the spherical aberration occurring when the laser beam L1 passing through the optical disc 2 can be canceled by the spherical aberration occurring in the objective lens 24 when the laser beam L1 is made to converge on the deepest recording layer of the optical disc 2. Furthermore, FIG. 4(C) shows the setting where the spherical aberration occurring when the laser beam L1 passing through the optical disc 2 can be canceled by the spherical aberration occurring in the objective lens 24 when the laser beam L1 is made to converge on the outermost recording layer of the optical disc 2.

When the collimator lens 22 is located at the reference position, both the laser diode 20 and the photodiode 25 are located at focal positions for the collimator lens 22. Therefore, in any of the cases shown in FIG. 4(A) to (C), the distance between the laser diode 20 and the collimator lens 22 is equal to the distance between the photodiode 25 and the collimator lens 22.

Therefore, as is apparent from comparison between FIG. 4(A) to FIG. 4(C), it is understood that the laser diode 20 and the photodiode 25 can be moved closer to the polarization beam splitter 21 by setting the reference position of the collimator lens 22 to an end of the movable range of the collimator lens 22 closer to the objective lens 24 as shown in FIG. 4(C).

The optical pickup 16 according to this embodiment is configured so that the reference position of the collimator lens 22 is set to an end (approximately the end) of the movable range of the collimator lens 22 that is closest to the objective lens 24, thereby making it possible to locate the laser diode 20 and the photodiode 25 at positions closer to the polarization beam splitter 21.

Furthermore, since the optical pickup 16 according to this embodiment is also configured so that the reference position of the collimator lens 22 is set to an end of the movable range R of the collimator lens 22 that is closest to the objective lens 24, the objective lens 24 is formed so that when the laser beam L1 is made to converge on the outermost recording layer of the optical disc 2, spherical aberration occurring in the laser beam L1 on the optical disc 2 can be canceled by spherical aberration occurring in the objective lens 24.

According to this embodiment as described above, the reference position of the collimator lens 22 for the optical pickup 16 is set to an end of the movable range R of the collimator lens 22 that is closest to the objective lens 24; and the objective lens 24 is formed so that when the laser beam L1 is made to converge on the outermost recording layer of the optical disc 2, spherical aberration occurring in the laser beam L1 in the optical disc 2 can be canceled by spherical aberration occurring in the objective lens 24. Therefore, the laser diode 20 and the photodiode 25 can be located at positions closer to the polarization beam splitter 21. As a result, the optical pickup 16 and hence the whole optical disc device 1 can be further downsized.

### (2) Second Embodiment

An optical disc is generally slightly decentered. So, tracking control of an optical disc device is performed by inclining (tilting) an objective lens in a radial direction of the optical disc according to displacement of tracks in order to make the laser beam follow the tracks displaced along with rotation of the optical disc.

Therefore, if the method of having the laser beam diverge or converge by moving the collimator lens as in the first embodiment is used, relative axial misalignment occurs in the laser beam entering the objective lens as the objective lens is tilted; and as a result, coma aberration occurs in the laser beam passing through the objective lens.

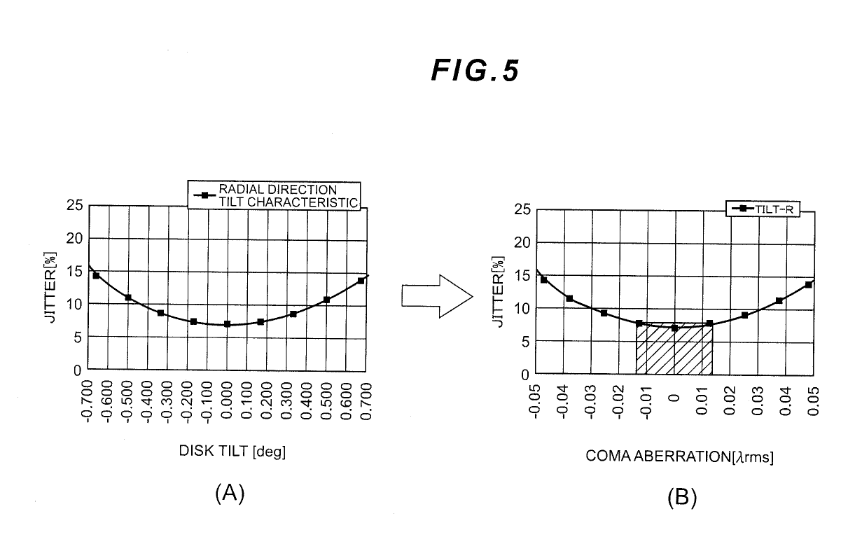

FIG. 5(A) shows the experiment results of a jitter characteristic occurring in a reduced signal when gradually tilting the objective lens, where a BD-ROM disc having a thickness of 0.1 [mm] from its plane of laser beam incidence to its outermost recording layer is used as the optical disc. FIG. 5(B) shows the results of simulating the relationship between jitter and coma aberration occurring in the laser beam by replacing the disc tilt amount on the horizontal axis in FIG. 5A with the coma aberration by means of simulation.

As is apparent from FIG. 5(A), a jitter amount occurring in the regenerated signal increases along with an increase of the coma aberration occurring in the laser beam passing through the objective lens (that is, along with an increase of a tilt angle of the disc). This simulation result shows that the coma aberration amount which will cause almost no change in regeneration performance is within the range of approximately ±0.014 [λrms] as shown in FIG. 5(B).

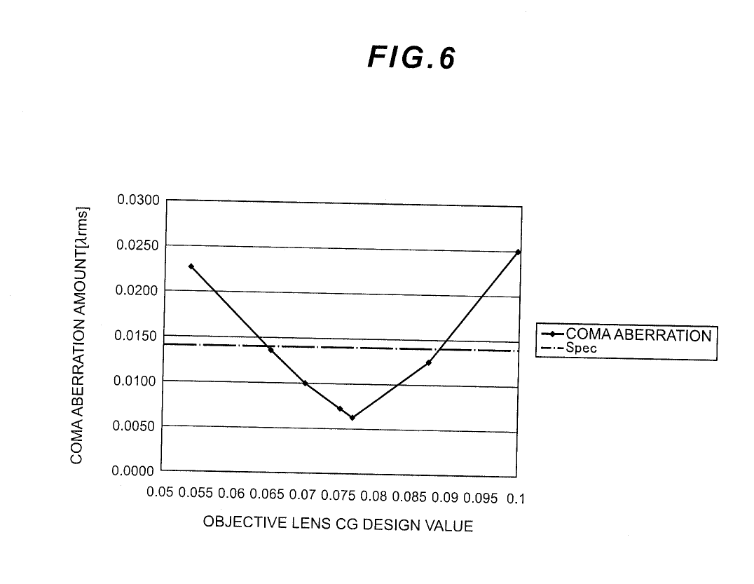

On the other hand, FIG. 6 shows the result of simulating the size of coma aberration occurring when a shift amount of the objective lens is 0.2 [mm] in a state where the position of the collimator lens is adjusted to minimize the spherical aberration (to make the spherical aberration 0.001 [λrms] or less) in a recording layer located at a position farthest from a cancellable disc thickness (defined below), with respect to a plurality of objective lenses with different thicknesses of an optical disc from its plane of laser beam incidence for which spherical aberration occurring in the optical disc can be canceled by spherical aberration occurring in the relevant objective lens (hereinafter referred to as the “cancellable disc thickness(es)). In this simulation, the use of objective lenses having the cancellable disc thicknesses of 0.1 [mm], 0.875 [mm], 0.07675 [mm], 0.075 [mm], 0.065 [mm], and 0.0535 [mm] is assumed.

FIG. 6 apparently shows that the spherical aberration in the recording layer at a position farthest from the cancellable disc thickness is minimum when the objective lens whose cancellable disc thickness is 0.07675 [mm] is used; and as the cancellable disc thickness increases or decreases from the above-mentioned value, the coma aberration increases.

FIG. 6 also shows that the cancellable disc thickness of the objective lens ranges from 0.065 to 0.875 [mm] when the coma aberration is within the range of approximately ±0.014 [λrms] as described earlier with reference to FIG. 5(B). In this case, a thinner cancellable disc thickness of the objective lens can further downsize the configuration of the optical pickup as described in the first embodiment. Accordingly, if the cancellable disc thickness is set to a value, that is, 0.07675 [mm] or less that will minimize the coma aberration, it is possible to downsize the optical pickup and realize the configuration with reduced coma aberration. Specifically speaking, if the reference position of the collimator lens that makes the laser beam which has transmitted through the collimator lens become parallel rays is set between an approximately center area of the movable range of the collimator lens and an end of the movable range closer to the objective lens and the cancellable disc thickness of the objective lens is set to be within the range of 0.065 to 0.07675 [mm], it is possible to downsize the optical pickup and secure regeneration performance by reduction of the coma aberration. Also, since such downsizing of the device can be realized in millimeters [mm], the above-described configuration is very effective particularly in an optical pickup mounted in a slim disc drive capable of data recording and/or regeneration on a multilayered disc.

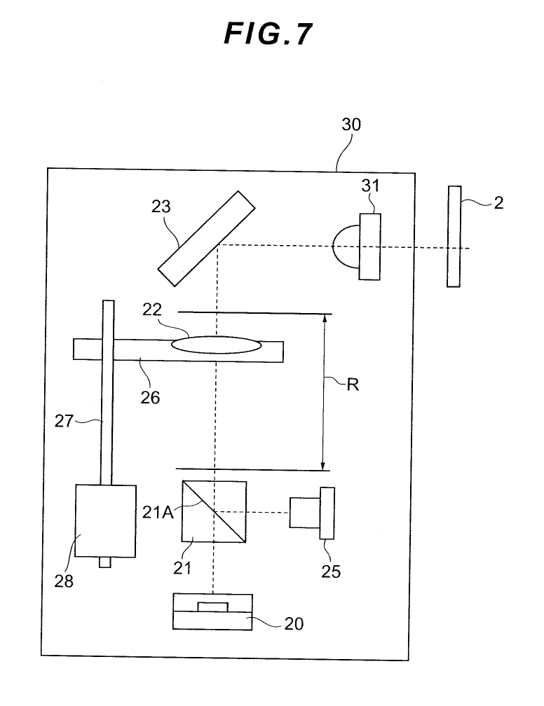

FIG. 7 shows an example of an optical pickup 30 according to this embodiment based on the above-described principle. This optical pickup 30 is used, instead of the optical pickup 16 according to the first embodiment, in the optical disc device 1 described earlier with reference to FIG. 1; and is configured in almost the same manner as the optical pickup 16 according to the first embodiment, except that the cancellable disc thickness of an objective lens 31 is 0.065 [mm].

With the optical pickup 30 according to this embodiment, the cancellable disc thickness of the objective lens 31 is set to a minimum value, for example, 0.065 [mm] where the coma aberration will be within the range of approximately ±0.014 [λrms]. As a result, it is possible to downsize the overall configuration and inhibit the occurrence of jitter in the regenerated signal. However, it is a matter of course that the cancellable disc thickness of the objective lens is not limited to the above-mentioned value; and if the cancellable disc thickness of the objective lens is set to be within the range of 0.065 to 0.07675 [mm], it is possible to downsize the optical pickup and secure regeneration performance by reduction of the coma aberration.

Incidentally, in the case of the optical pickup 30 according to this embodiment, if the distance between the plane of laser beam incidence of the optical disc 2 and its outermost recording layer is 0.065 [mm] or more, the reference position of the collimator lens 22 will be located at an end of the movable range R of the collimator lens 22 that is closest to the objective lens 31; and if the distance between the plane of laser beam incidence of the optical disc 2 and its outermost recording layer is less than 0.065 [mm], the reference position of the collimator lens 22 will be located at a position away from the objective lens 31 farther from the end of the movable range R of the collimator lens 22 that is closest to the objective lens 31.

In this case, to what degree the reference position of the collimator lens 22 will be moved away from the objective lens 31 farther from the end of the movable range R of the collimator lens 22 that is closest to the objective lens 31 depends on, for example, the distance between the plane of laser beam incidence of the optical disc 2 and its outermost recording layer.

### (3) Other Embodiments

The first and second embodiments have described the case where the present invention is used in the optical pickup 16, 30 configured as shown in FIG. 2 or FIG. 7; however, the invention is not limited to this example and can be used in a wide variety of optical pickups having other various configurations.

The first and second embodiments have also described the case where the collimator lens moving unit for moving the collimator lens 22 along the optical path of the laser beam L1 in a direction approaching the objective lens 24, 31 or a direction moving away from the objective lens 24, 31 is constituted from the holder 26, the ball screw 27, and the stepping motor 28; however, the invention is not limited to this example and a wide variety of other configurations can be used as the configuration of the collimator lens moving unit as long as the collimator lens 22 can be moved along the optical path of the laser beam L1 in a direction approaching the objective lens 24, 31 or a direction moving away from the objective lens 24, 31.

The present invention can be used in an optical pickup mounted in an optical disc device that is capable of data recording and/or regeneration on multilayered optical discs.

What is claimed is:

1. An optical pickup mounted in an optical disc device capable of data recording and/or regeneration on a multilayered optical disc having a plurality of recording layers,
the optical pickup comprising:
a laser diode for emitting a laser beam;
an objective lens for making the laser beam, which has been emitted from the laser diode, converge on the recording layers of the multilayered optical disc;
a collimator lens positioned on an optical path of the laser beam between the laser diode and the objective lens; and
a collimator lens moving unit for moving the collimator lens along the optical path of the laser beam in a direction approaching the objective lens or a direction moving away from the objective lens;
wherein a reference position of the collimator lens where the laser beam which has transmitted the collimator lens becomes parallel rays is set between an approximately center area of a movable range of the collimator lens to an end of the movable range closer to the objective lens; and
wherein the objective lens is formed so that spherical aberration occurring in the laser beam which is made to converge on an outermost recording layer of the multilayered optical disc that is closest to the objective lens can be cancelled by spherical aberration occurring in the laser beam entering the objective lens through the collimator lens located at the reference position.

2. The optical pickup according to claim 1, wherein the multilayered optical disc is a Blu-ray Disc having a plurality of recording layers.

3. The optical pickup according to claim 1, wherein the objective lens is formed so that a thickness of the optical disc from its plane of laser beam incidence where the spherical aberration occurring in the optical disc can be canceled by the spherical aberration occurring in the objective lens itself will be in the range of 0.065 [mm] to 0.077 [mm].

4. The optical pickup according to claim 1, wherein the objective lens is formed so that a thickness of the optical disc from its plane of laser beam incidence where the spherical aberration occurring in the optical disc can be canceled by the spherical aberration occurring in the objective lens itself will be approximately 0.065 [mm].
